(19) United States
(12) Patent Application Publication
(10) Pub. No.: US 2020/0265612 A1
(43) Pub. Date: Aug. 20, 2020

(54) AUTOMATIC PATENT DRAWINGS DISPLAYING DEVICE

(71) Applicant: Integral Search International Ltd., Taipei (TW)

(72) Inventor: Hong-Shin TSAI, Taipei (TW)

(21) Appl. No.: 16/747,147

(22) Filed: Jan. 20, 2020

(30) Foreign Application Priority Data
Feb. 20, 2019 (TW) 108105661

(51) Int. Cl. G06T 11/00; G06Q 50/18

(52) U.S. Cl. CPC G06T 11/00; G06Q 50/184

(57) ABSTRACT

Disclosed is an automatic patent drawings displaying device for displaying drawings corresponding to a paragraph of a patent document, the automatic patent drawings displaying device comprising a drawing number distribution determining element, a drawing-to-drawing-number determining element, a description-to-drawing determining element and a drawing displaying element.

### CROSS-REFERENCE TO RELATED APPLICATION

This application claims priority to Taiwanese Patent Application No. 108105661 filed Feb. 20, 2019, entitled “Automatic Graphic Displaying Equipment For Patent Document”, which is incorporated by reference herein in its entirety.

### FIELD OF THE INVENTION

The present invention relates to an automatic drawings displaying device, and more particularly relates to an automatic patent drawings displaying device.

### BACKGROUND OF THE INVENTION

Patent reading involves professional skill including the precise reading of all patent sections such as “ABSTRACT”, “FIELD OF THE INVENTION”, “BACKGROUND OF THE INVENTION”, “SUMMARY OF THE INVENTION”, “BRIEF DESCRIPTION OF THE DRAWINGS”, “DETAILED DESCRIPTION OF THE PREFERRED EMBODIMENTS”, “CLAIMS” and “DRAWINGS”, and the cross reference among these patent sections. In general, in order to comprehend the technical content of a patent document in a quicker and precise way, a patent reader is required to repeatedly refer to the patent section of “DRAWINGS”. However, in conventional patent reading interface, the patent section of “DRAWINGS” is placed in a patent location different from that of other patent sections. It thus causes patent readers to be very inconvenient because the patent reader is necessary to jump back and forth between different patent sections when reading. In addition, patent readers have to find by himself/herself which drawing/drawings should correspond to the reading paragraph, by which the exhausting repeating comparison is required and the unexpected mistakes happen.

Therefore, it is an issue about how to utilize an automatic equipment to automatically determine and establish corresponding relationships among the reading paragraphs and the drawings of the patent document so as to automatically provide the patent reader with the most comfortable displaying interface for reading the patent specification and the drawings. And more particularly it is an issue about how to automatically provide the patent reader with the drawings which could be automatically displayed.

### SUMMARY OF THE INVENTION

Accordingly, one of the objectives of the present invention is to provide an automatic patent drawings displaying device which utilizes an automatic equipment to carry out automatically determining and establishing corresponding relationships among the paragraphs and the drawings of the patent document. Further, the present invention is provided to utilize the automatic equipment to automatically enable a drawing/drawings corresponding to the paragraph and the paragraph itself together to be displayed simultaneously to assist the patent reader to read the patent document in more correct, quicker and more efficient way.

In order to overcome the technical problems in prior art, the present invention provides an automatic patent drawings displaying device for displaying drawings of a patent document, the automatic patent drawings displaying device being configured to display drawings corresponding to a paragraph of the patent document, the patent document comprising a patent section of “BRIEF DESCRIPTION OF THE DRAWINGS”, a patent section of “DETAILED DESCRIPTION OF THE PREFERRED EMBODIMENTS” and a patent section of “DRAWINGS”, the patent section of “BRIEF DESCRIPTION OF THE DRAWINGS” and the patent section of “DETAILED DESCRIPTION OF THE PREFERRED EMBODIMENTS” being formed by the paragraphs, the automatic patent drawings displaying device comprising: a drawing number distribution determining element, which utilizes a processor to obtain a descriptive drawing number from the patent section of “BRIEF DESCRIPTION OF THE DRAWINGS” to obtain drawing number distribution information of the patent section of “BRIEF DESCRIPTION OF THE DRAWINGS” and store the drawing number distribution information in a memory; a drawing-to-drawing-number determining element, which is connected to the drawing number distribution determining element, the drawing-to-drawing-number determining element utilizing the processor to read the drawing number distribution information from the memory and access all drawings from the patent section of “DRAWINGS”, the drawing-to-drawing-number determining element being configured to determine a drawing-to-drawing-number relationship for all drawings, take the drawing-to-drawing-number relationship as drawing-to-drawing-number information and store the drawing-to-drawing-number information in the memory, the drawing-to-drawing-number relationship being determined according to the descriptive drawing number of the drawing number distribution information and being taken as drawing-to-drawing-number information; a description-to-drawing determining element which is connected to the drawing-to-drawing-number determining element, the description-to-drawing determining element utilizing the processor to read the drawing-to-drawing-number information from the memory, determine description-to-drawing relationship for all paragraphs of the patent section of “DETAILED DESCRIPTION OF THE PREFERRED EMBODIMENTS”, take the description-to-drawing relationship as description-to-drawing information and store the description-to-drawing information in the memory, wherein the description-to-drawing relationship is obtained to determine the drawing to which each paragraph of the patent section of “DETAILED DESCRIPTION OF THE PREFERRED EMBODIMENTS” belongs, the determination being performed based on the drawing-to-drawing-number information and a position of the drawing number that is descriptive in the patent section of “DETAILED DESCRIPTION OF THE PREFERRED EMBODIMENTS”; and a drawing displaying element which is connected to the description-to-drawing determining element, and the drawing displaying element utilizing the processor to read the description-to-drawing information from the memory such that, when a paragraph in the patent section of “DETAILED DESCRIPTION OF THE PREFERRED EMBODIMENTS” is selected, the drawing corresponding to the selected paragraph is displayed according to the description-to-drawing information.

In the automatic patent drawings displaying device according to one embodiment of the present invention, the drawing-to-drawing-number determining element has a drawing-quantity-and-distribution determining sub-element, the drawing-quantity-and-distribution determining sub-element utilizes the processor to scan each individual page of the patent section of “DRAWINGS” to determine a drawing quantity of each individual page to obtain drawing quantity information and drawing distribution information of the patent document before determining the drawing-to-drawing-number relationship for all drawings in the patent section of “DRAWINGS” and store the drawing quantity information and the drawing distribution information in the memory, and the drawing-to-drawing-number determining element determines the drawing-to-drawing-number information according to the drawing quantity information, the drawing distribution information and the drawing number distribution information and stores the drawing-to-drawing-number information in the memory.

In the automatic patent drawings displaying device according to one embodiment of the present invention, the description-to-drawing determining element encloses all sentences, in the patent section of “DETAILED DESCRIPTION OF THE PREFERRED EMBODIMENTS”, from a paragraph with one drawing number to following sentences before a paragraph with another drawing number different from said one drawing number such that the enclosed sentences are assigned with said one drawing number.

In the automatic patent drawings displaying device according to one embodiment of the present invention, the description-to-drawing determining element encloses all sentences, in the patent section of “DETAILED DESCRIPTION OF THE PREFERRED EMBODIMENTS”, from a sentence with one drawing number to following sentences before a sentence with another drawing number different from said one drawing number such that the enclosed sentences are assigned with said one drawing number.

In the automatic patent drawings displaying device according to one embodiment of the present invention, when an element noun or an interrelationship definition of a paten section of “CLAIMS” of the patent document is selected, the drawing displaying element displays the drawing corresponding to the element noun or the interrelationship definition in the paragraph of the patent section of “DETAILED DESCRIPTION OF THE PREFERRED EMBODIMENTS”.

In the automatic patent drawings displaying device according to one embodiment of the present invention, the drawing displaying element enables the selected paragraph and the drawing corresponding to the selected paragraph to be displayed.

In the automatic patent drawings displaying device according to one embodiment of the present invention, the drawing displaying element enables the drawing to be displayed in a manner that the drawing corresponding to the paragraph is fixed relative to a display screen and the paragraph is scrollable according to a scrolling up/down operation.

In the automatic patent drawings displaying device according to one embodiment of the present invention, the drawing displaying element is configured to enable a plurality of drawings to be displayed when the plurality of drawings corresponds to any portion of the selected paragraph in the patent section of “DETAILED DESCRIPTION OF THE PREFERRED EMBODIMENTS”.

The automatic patent drawings displaying device according to the present invention has following technical effects. The present invention automatically determines and automatically establishes corresponding relationships among the paragraphs and the drawings of the patent document to automatically enable a drawing/drawings corresponding to the paragraph and the paragraph itself together to be displayed simultaneously when the paragraph of the patent document is selected by the patent reader to assist the patent reader to read the patent document in more correct, quicker and more efficient way.

### BRIEF DESCRIPTION OF THE DRAWINGS

FIG. 1 is a schematic block diagram illustrating an automatic patent drawings displaying device according to one embodiment of the present invention;

FIG. 2 is a schematic diagram illustrating a paragraph of a patent document;

FIG. 3 is a schematic diagram illustrating drawing-to-drawing-number information in the automatic patent drawings displaying device according to the embodiment of the present invention;

FIG. 4 is a schematic block diagram illustrating a description-to-drawing determining element of the automatic patent drawings displaying device according to the embodiment of the present invention;

FIG. 5 is a schematic diagram illustrating a patent section of “DRAWINGS” of the patent document;

FIG. 6 is a schematic diagram illustrating a patent section of “DETAILED DESCRIPTION OF THE PREFERRED EMBODIMENTS” of the patent document;

FIG. 7 is a schematic diagram illustrating description-to-drawing information in the automatic patent drawings displaying device according to the embodiment of the present invention;

FIG. 8 is a schematic diagram illustrating one display screen of a drawing displaying element in the automatic patent drawings displaying device according to the embodiment of the present invention;

FIG. 9 is a schematic diagram illustrating one display screen of the drawing displaying element in the automatic patent drawings displaying device according to the embodiment of the present invention; and

FIG. 10 is a schematic diagram illustrating one display screen of the drawing displaying element in the automatic patent drawings displaying device according to the embodiment of the present invention.

### DETAILED DESCRIPTION OF THE PREFERRED EMBODIMENTS

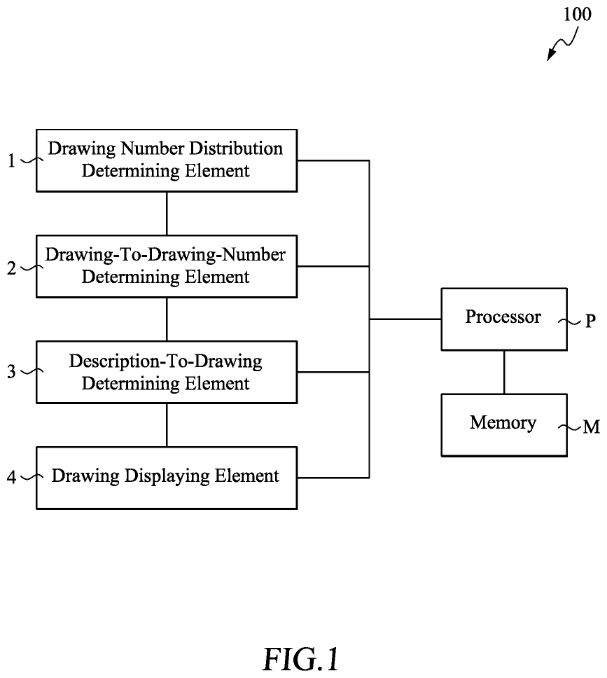

The preferred embodiments of the present invention are described in detail below with reference to FIG. 1 to FIG. 10. The description is used for explaining the embodiments of the present invention only, but not for limiting the scope of the claims.

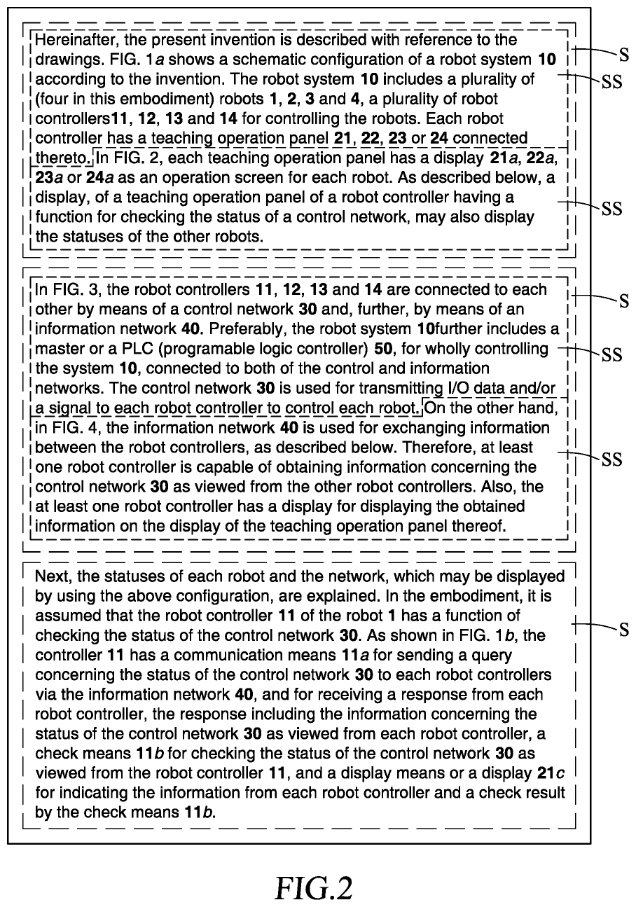

FIG. 1 is a system block diagram of an automatic patent drawings displaying device according to one embodiment of the present invention, wherein the automatic patent drawings displaying device 100 is configured to display drawings corresponding to a paragraph of a patent document. The following embodiments of the present invention are exemplified by an English patent specification, but the present invention is not limited thereto, and a patent specification in any language may be used. A patent document generally includes a plurality of patent sections, including: “ABSTRACT”, “FIELD OF THE INVENTION”, “BACKGROUND OF THE INVENTION”, “SUMMARY OF THE INVENTION”, “BRIEF DESCRIPTION OF THE DRAWINGS”, “DETAILED DESCRIPTION OF THE PREFERRED EMBODIMENTS”, “CLAIMS” and “DRAWINGS”. The term of paragraph refers to a paragraph in one of the patent sections. For example, the paragraph could be a paragraph of the patent section “DETAILED DESCRIPTION OF THE PREFERRED EMBODIMENTS”, a sub-portion of a paragraph of the patent section “DETAILED DESCRIPTION OF THE PREFERRED EMBODIMENTS”, an element noun in the patent section of “CLAIMS”, or an interrelationship definition in the patent section of “CLAIMS”. As shown in FIG. 2, a reference symbol S refers to the paragraph, and a reference symbol SS refers to a sub-paragraph of one paragraph.

The automatic patent drawings displaying device in the present invention is mainly characterized in that an automatic equipment is utilized to automatically determine and automatically establish a corresponding relationship between a paragraph of the patent document and the drawing to enable the paragraph and the drawing corresponding to the paragraph in the patent document to be automatically and simultaneously displayed.

The automatic patent drawings displaying device 100 according to the embodiment of the present invention includes a drawing number distribution determining element 1, which utilizes a processor P to obtain a descriptive drawing number from the patent section “BRIEF DESCRIPTION OF THE DRAWINGS” to obtain drawing number distribution information from the patent section “BRIEF DESCRIPTION OF THE DRAWINGS” and store the drawing number distribution information in a memory M.

“BRIEF DESCRIPTION OF THE DRAWINGS” is one of the patent sections in a patent document, which is exemplary expressed as follows:

### “BRIEF DESCRIPTION OF THE DRAWINGS

The above and other objects, features and advantages of the present invention will be made more apparent by the following description of the preferred embodiments thereof, with reference to the accompanying drawings, wherein:

FIG. 1a shows a schematic configuration of a robot system according to the present invention;

FIG. 1b shows a detailed constitution of a robot controller as shown in FIG. 1a;

FIG. 2 shows a display of a teaching operation panel of the robot controller;

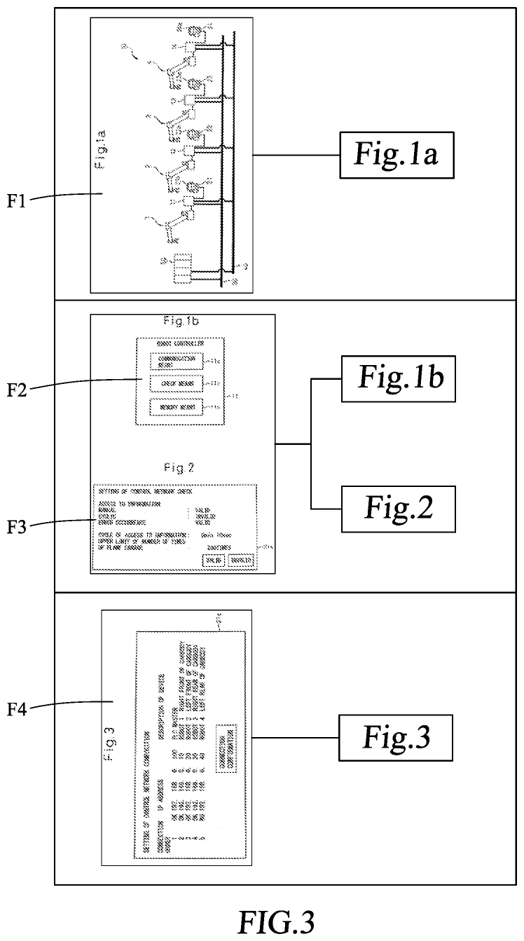

FIG. 3 shows an example of a setting display of the composition of a control network.”

The drawing number distribution determining element 1 in the present invention utilizes the processor P to read the patent section of “BRIEF DESCRIPTION OF THE DRAWINGS” to obtain a plurality of drawing numbers, i.e., “FIG. 1a”, “FIG. 1b”, “FIG. 2” and “FIG. 3”, and the drawing numbers read are drawing number distribution information of the patent document, wherein the drawing number distribution information describes the existence and displaying sequence of all drawing numbers. The drawing number distribution information is stored in the memory M.

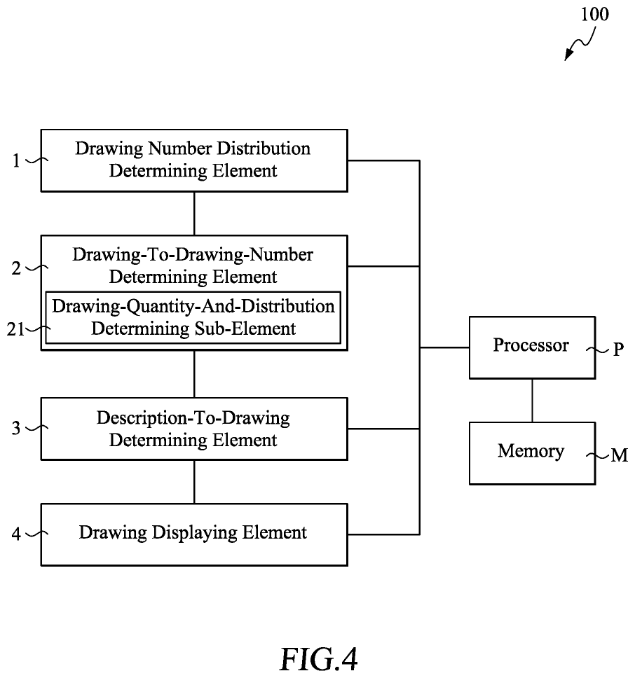

As shown in FIG. 4, the automatic patent drawings displaying device 100 according to the embodiment of the present invention has a drawing-to-drawing-number determining element 2, which is connected to the drawing number distribution determining element 1. The drawing-to-drawing-number determining element 2 utilizes the processor P to read the drawing number distribution information from the memory M and access all drawings from the patent section of “DRAWINGS”. The drawing-to-drawing-number determining element 2 is configured to determine a drawing-to-drawing-number relationship for all drawings, take the drawing-to-drawing-number relationship as drawing-to-drawing-number information and store the drawing-to-drawing-number information in the memory M. The drawing-to-drawing-number relationship is determined according to the descriptive drawing number of the drawing number distribution information and is taken as drawing-to-drawing-number information.

In other words, the drawing-to-drawing-number determining element 2 in the present invention is configured to read the drawing number distribution information (i.e., “FIG. 1a”, “FIG. 1b”, “FIG. 2” and “FIG. 3”) from the memory M and access all drawings from the patent section of “DRAWINGS”. After all drawings have been read, the drawing numbers recorded in the drawing number distribution information are available as corresponding to each drawing F1, F2, F3 and F4 to thus obtain a drawing-to-drawing-number relationship. The drawing-to-drawing-number relationship is taken as the drawing-to-drawing-number information, as shown in FIG. 3. The drawing-to-drawing-number information is then stored in the memory M.

As shown in FIG. 4, in one embodiment of the present invention, the drawing-to-drawing-number determining element 2 further has a drawing-quantity-and-distribution determining sub-element 21. The drawing-quantity-and-distribution determining sub-element 21 utilizes the processor P to scan each individual page of the patent section of “DRAWINGS” to determine a drawing quantity of each individual page, thereby obtaining drawing quantity information and drawing distribution information of the patent document before determining the drawing-to-drawing-number relationship for all drawings in the patent section of “DRAWINGS”. The drawing quantity information and the drawing distribution information are then stored in the memory M. The drawing-to-drawing-number determining element 2 determines the drawing-to-drawing-number information according to the drawing quantity information, the drawing distribution information and the drawing number distribution information. The drawing-to-drawing-number information are then stored in the memory M.

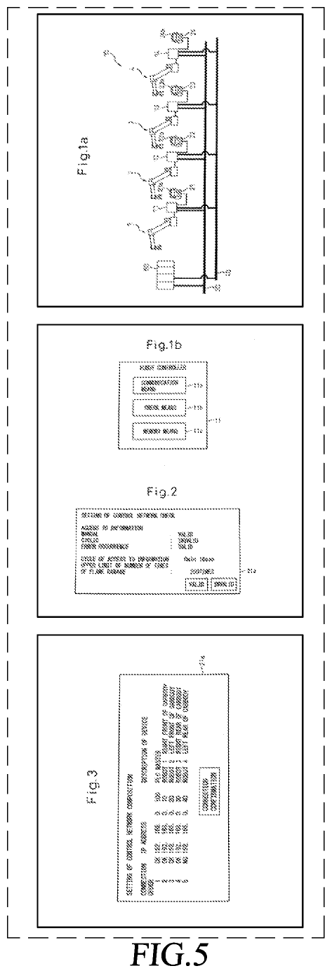

In detail, as shown in FIG. 5, the patent section of “DRAWINGS” generally includes a plurality of individual pages, and each individual page contains one or more drawings. The drawing-quantity-and-distribution determining sub-element 21 determines the drawing quantity of each individual page. The drawing-quantity-and-distribution determining sub-element 21 scans each individual page of the patent section of “DRAWINGS” to determine the drawing quantity of each individual page according to the characteristics of drawing aggregation area, the drawing aggregation shape and other characteristics. In one embodiment, an OpenCV software of Python's library can be used, and the drawing quantity of each individual page can be determined by using the OpenCV software in which the functions of drawing area, shape and comparison are used. For example, in the case that a space threshold of 8% is set, when the drawing-quantity-and-distribution determining sub-element 21 determines that there are two patterns respectively occupying 30% and 60% of the area in one individual page, and there is a 10% space area therebetween, since 10% space area is with value greater than the space threshold of 8%, the drawing-quantity-and-distribution determining sub-element 21 can determine that the individual page contains two drawings. Accordingly, the drawing quantity information and drawing distribution information of the patent document can be obtained. For example, as shown in FIG. 5, a patent section of “DRAWINGS” contains three individual pages, wherein the first one of the individual pages contains one drawing, the second one of the individual pages contains two drawings, and the third one of the individual pages contains one drawing, and the patent section of “DRAWINGS” totally contains four drawings, in which the second one and the third one of the four drawings are in the second one of the individual pages. Accordingly, the information of “totally containing four drawings” is taken as the drawing quantity information, the relationship about which individual page contains which drawings is taken as the drawing distribution information. And the drawing quantity information and the drawing distribution information are stored in the memory M.

As shown in FIG. 1, the automatic patent drawings displaying device 100 according to the embodiment of the present invention has a description-to-drawing determining element 3 which is connected to the drawing-to-drawing-number determining element 2. The description-to-drawing determining element 3 utilizes the processor P to read the drawing-to-drawing-number information from the memory M, determine description-to-drawing relationship for all paragraphs of the patent section of “DETAILED DESCRIPTION OF THE PREFERRED EMBODIMENTS”, take the description-to-drawing relationship as description-to-drawing information and store the description-to-drawing information in the memory M, wherein the description-to-drawing relationship is obtained to determine the drawing to which each paragraph of the patent section of “DETAILED DESCRIPTION OF THE PREFERRED EMBODIMENTS” belongs. The determination is performed based on the drawing-to-drawing-number information and a position of the drawing number that is descriptive in the patent section of “DETAILED DESCRIPTION OF THE PREFERRED EMBODIMENTS”.

In detail, the description-to-drawing determining element 3 is configured to determine which drawing or drawings belongs or belong to the paragraph in the patent section “DETAILED DESCRIPTION OF THE PREFERRED EMBODIMENTS”, wherein the paragraph includes a paragraph or a sub-portion of a paragraph in the patent section of “DETAILED DESCRIPTION OF THE PREFERRED EMBODIMENTS”, or determine which drawing or drawings belongs or belong to an element noun or an interrelationship definition of the paten section of “CLAIMS”. In one embodiment of the present invention, the drawing numbers belonging to each paragraph of the patent section of “DETAILED DESCRIPTION OF THE PREFERRED EMBODIMENTS” are determined based on a position of the drawing number that is descriptive in the patent section of “DETAILED DESCRIPTION OF THE PREFERRED EMBODIMENTS” of the patent document.

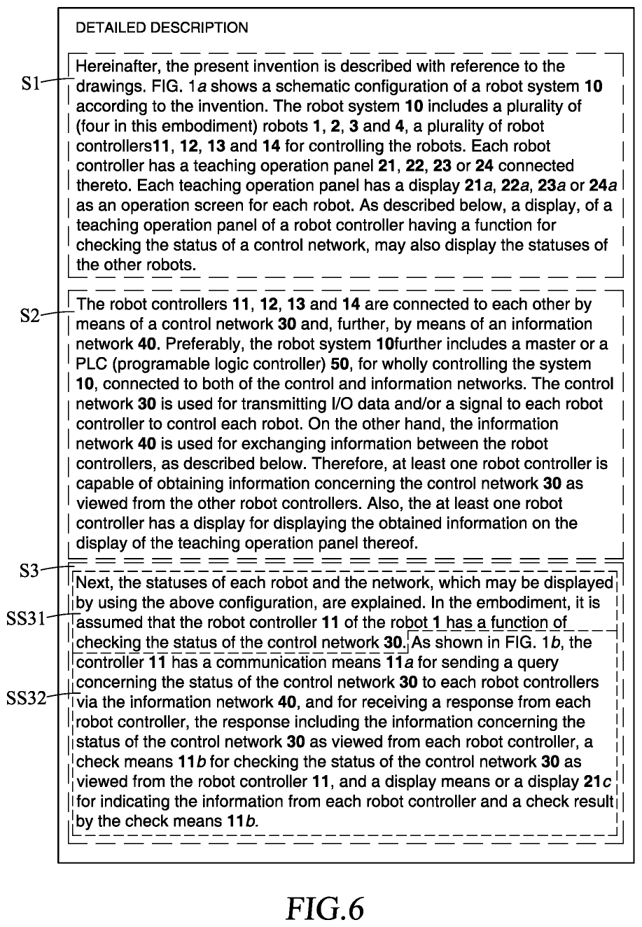

As shown in FIG. 6 for the detail, in the paragraph S1, “FIG. 1a” is the only drawing number shown, and therefore the paragraph S1 is determined having the drawing number of “FIG. 1a”. In the second paragraph S2, there is not any drawing number, and therefore the second paragraph S2 is determined as having drawing number of “FIG. 1a”. In other words, if a paragraph is not shown with any drawing number, the paragraph will inherit the drawing number from its previous paragraph. In the third paragraph S3, there is a drawing number of “FIG. 1b” shown in the middle of the third paragraph S3, and therefore the drawing number for a sub-portion SS31 of the paragraph inherits the drawing number “FIG. 1a”, and the drawing number for a sub-portion SS32 of the paragraph is with drawing number of “FIG. 1b”. In addition, in another embodiment of the present invention, the description-to-drawing determining element 3 encloses all sentences between two drawing numbers to correspond to a prior drawing number. In detail, the description-to-drawing determining element 3 determines the enclosed sentences from a sentence with the prior drawing number to sentence prior to the latter drawing number, and takes the enclosed sentences to correspond to the prior drawing number no matter the latter drawing number is or not in the same paragraph as that of the latter drawing number.

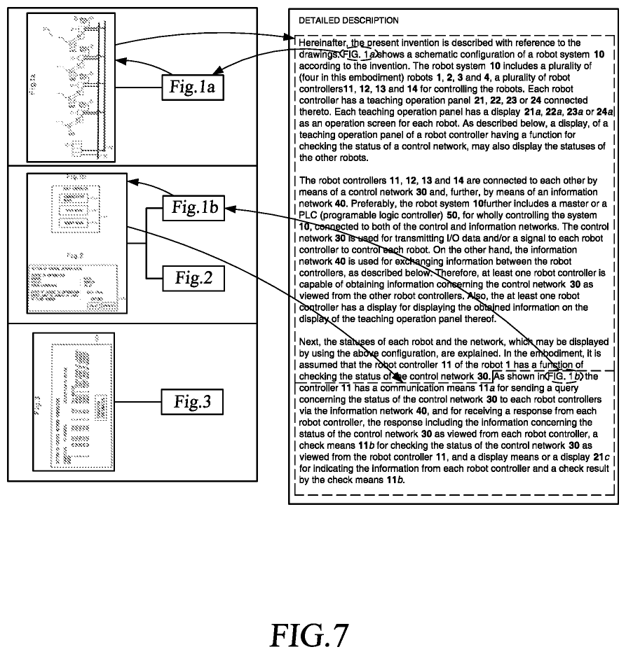

As shown in FIG. 7, since the drawing-to-drawing-number information, i.e., the drawing numbers belonging to each drawing of the patent section of “DRAWINGS”, and the description-to-drawing information, i.e., the drawing numbers corresponding to each paragraph or a sub-portion of a paragraph of the patent section “DETAILED DESCRIPTION OF THE PREFERRED EMBODIMENTS”, have been obtained, the drawing belonging to each paragraph or sub-portion of each paragraph of the patent section of “DETAILED DESCRIPTION OF THE PREFERRED EMBODIMENTS” could be determined according to the drawing-to-drawing-number information and the description-to-drawing information.

As shown in FIG. 1, in the embodiment of the present invention, the automatic patent drawings displaying device 100 has a drawing displaying element 4 which is connected to the description-to-drawing determining element 3. The drawing displaying element 4 utilizes the processor P to read the description-to-drawing information from the memory M. When a paragraph in the patent section of “DETAILED DESCRIPTION OF THE PREFERRED EMBODIMENTS” is selected, the drawing corresponding to the selected paragraph is displayed according to the description-to-drawing information.

As described above, when the drawing quantity information of the patent section of “DRAWINGS” is different from a quantity of the drawing number in the drawing number distribution information and the difference having difference value is greater than 2, all drawings are displayed. However, the present invention is not limited to the difference value.

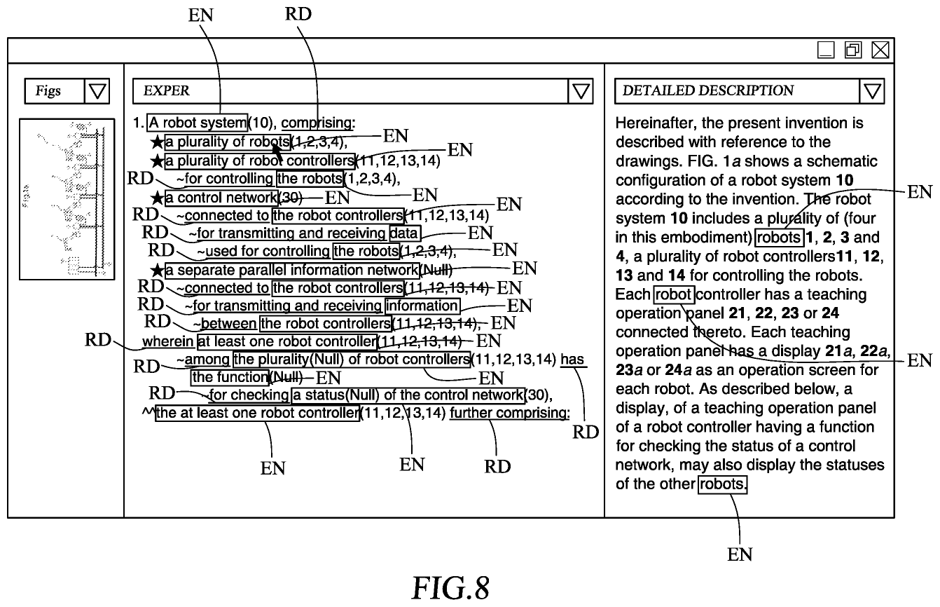

As shown in FIG. 8, in the automatic patent drawings displaying device 100 according to the embodiment of the present invention, when an element noun or an interrelationship definition defined in the paten section of “CLAIMS” of the patent document is selected, the drawing displaying element 4 displays the drawing or drawings corresponding to the paragraph where the element noun or the interrelationship definition are found in the paragraph of the patent section of “DETAILED DESCRIPTION OF THE PREFERRED EMBODIMENTS”. For example, when an element noun EN or an interrelationship definition RD is selected, the drawing displaying element 4 searches a paragraph or a sub-portion of the paragraph where the element noun or the interrelationship definition is existed in the patent section of “DETAILED DESCRIPTION OF THE PREFERRED EMBODIMENTS”. Thereafter the drawing corresponding to the drawing number of the searched paragraph or the sub-portion of paragraph where the element noun or the interrelationship definition is existed is displayed.

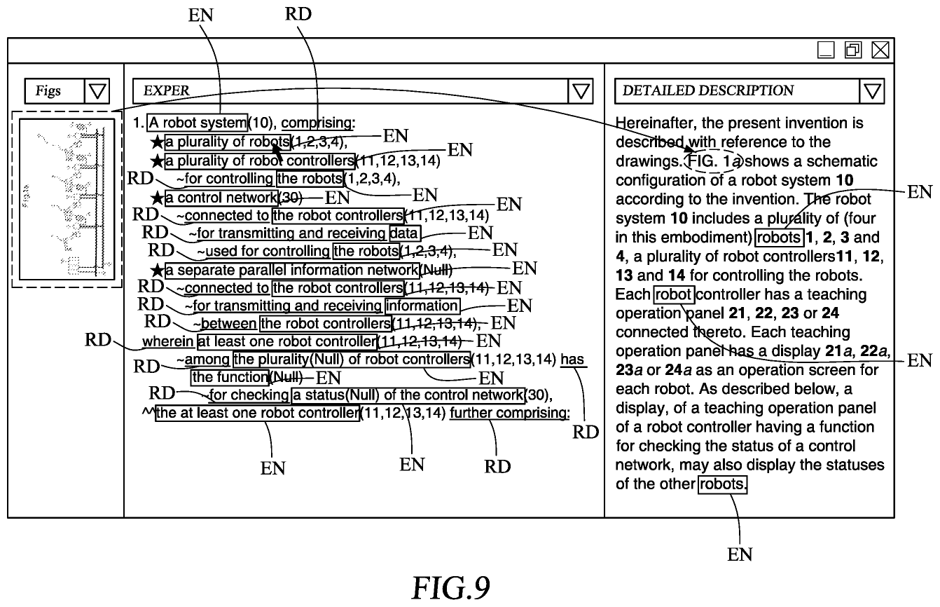

As shown in FIG. 9, in the automatic patent drawings displaying device 100 according to the embodiment of the present invention, the drawing displaying element 4 enables the selected paragraph and the drawing corresponding to the selected paragraph to be displayed. For example, when a reference number “3”, which belongs to an element noun “robot”, is selected by a click operation, the drawing of “FIG. 1a” is displayed in the left window.

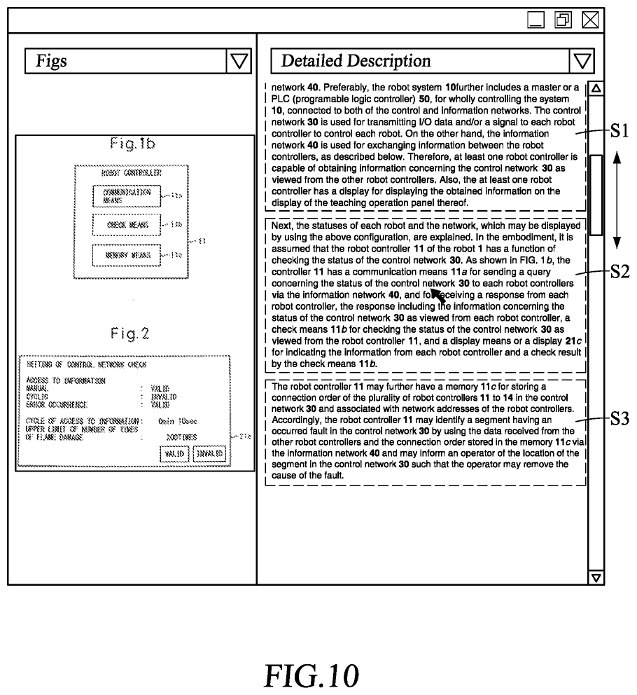

As shown in FIG. 10, in the automatic patent drawings displaying device 100 according to the embodiment of the present invention, a cursor as shown is movable among the paragraphs S1, S2 and S3 and, for example, when the cursor moves to a specific paragraph S2, the drawing corresponding to the paragraph S2 is displayed in a fixed position. The drawing displaying element 4 enables the drawing to be displayed in a manner that the drawing corresponding to the paragraph is displayed in a fixed position relative to a display screen, i.e., in the left window of the display screen in FIG. 10 such that a user could scroll the mouse among the paragraphs or click an up-and-down arrow as shown in FIG. 10 in a situation that the content in the left window is not changed. As shown in FIG. 10, when the cursor is on paragraph S2, all drawings corresponding to the paragraph S2 are displayed.

As shown in FIG. 9 and FIG. 10, in the automatic patent drawings displaying device 100 according to the embodiment of the present invention, the drawing displaying element 4 is configured to display all drawings when the plurality of drawing numbers is determined corresponding to the selected paragraph in the patent section of “DETAILED DESCRIPTION OF THE PREFERRED EMBODIMENTS”.

The above description is only an explanation of the preferred embodiments of the present invention. One having ordinary skill in the art can make various modifications according to the above description and the claims defined below. However, those modifications shall still fall within the scope of the present invention.

What is claimed is:

1. An automatic patent drawings displaying device for displaying drawings of a patent document, the automatic patent drawings displaying device being configured to display drawings corresponding to a paragraph of the patent document, the patent document comprising a patent section of “BRIEF DESCRIPTION OF THE DRAWINGS”, a patent section of “DETAILED DESCRIPTION OF THE PREFERRED EMBODIMENTS” and a patent section of “DRAWINGS”, the patent section of “BRIEF DESCRIPTION OF THE DRAWINGS” and the patent section of “DETAILED DESCRIPTION OF THE PREFERRED EMBODIMENTS” being formed by the paragraphs, the automatic patent drawings displaying device comprising:
a drawing number distribution determining element, which utilizes a processor to obtain a descriptive drawing number from the patent section of “BRIEF DESCRIPTION OF THE DRAWINGS” to obtain drawing number distribution information of the patent section of “BRIEF DESCRIPTION OF THE DRAWINGS” and store the drawing number distribution information in a memory;
a drawing-to-drawing-number determining element, which is connected to the drawing number distribution determining element, the drawing-to-drawing-number determining element utilizing the processor to read the drawing number distribution information from the memory and access all drawings from the patent section of “DRAWINGS”, the drawing-to-drawing-number determining element being configured to determine a drawing-to-drawing-number relationship for all drawings, take the drawing-to-drawing-number relationship as drawing-to-drawing-number information and store the drawing-to-drawing-number information in the memory, the drawing-to-drawing-number relationship being determined according to the descriptive drawing number of the drawing number distribution information and being taken as drawing-to-drawing-number information;
a description-to-drawing determining element which is connected to the drawing-to-drawing-number determining element, the description-to-drawing determining element utilizing the processor to read the drawing-to-drawing-number information from the memory, determine description-to-drawing relationship for all paragraphs of the patent section of “DETAILED DESCRIPTION OF THE PREFERRED EMBODIMENTS”, take the description-to-drawing relationship as description-to-drawing information and store the description-to-drawing information in the memory, wherein the description-to-drawing relationship is obtained to determine the drawing to which each paragraph of the patent section of “DETAILED DESCRIPTION OF THE PREFERRED EMBODIMENTS” belongs, the determination being performed based on the drawing-to-drawing-number information and a position of the drawing number that is descriptive in the patent section of “DETAILED DESCRIPTION OF THE PREFERRED EMBODIMENTS”; and
a drawing displaying element which is connected to the description-to-drawing determining element, and the drawing displaying element utilizing the processor to read the description-to-drawing information from the memory such that, when a paragraph in the patent section of “DETAILED DESCRIPTION OF THE PREFERRED EMBODIMENTS” is selected, the drawing corresponding to the selected paragraph is displayed according to the description-to-drawing information.

2. The automatic patent drawings displaying device as claimed in claim 1, wherein the drawing-to-drawing-number determining element has a drawing-quantity-and-distribution determining sub-element, the drawing-quantity-and-distribution determining sub-element utilizes the processor to scan each individual page of the patent section of “DRAWINGS” to determine a drawing quantity of each individual page to obtain drawing quantity information and drawing distribution information of the patent document before determining the drawing-to-drawing-number relationship for all drawings in the patent section of “DRAWINGS” and store the drawing quantity information and the drawing distribution information in the memory, and the drawing-to-drawing-number determining element determines the drawing-to-drawing-number information according to the drawing quantity information, the drawing distribution information and the drawing number distribution information and stores the drawing-to-drawing-number information in the memory.

3. The automatic patent drawings displaying device as claimed in claim 1, wherein the description-to-drawing determining element encloses all sentences, in the patent section of “DETAILED DESCRIPTION OF THE PREFERRED EMBODIMENTS”, from a paragraph with one drawing number to following sentences before a paragraph with another drawing number different from said one drawing number such that the enclosed sentences are assigned with said one drawing number.

4. The automatic patent drawings displaying device as claimed in claim 1, wherein the description-to-drawing determining element encloses all sentences, in the patent section of “DETAILED DESCRIPTION OF THE PREFERRED EMBODIMENTS”, from a sentence with one drawing number to following sentences before a sentence with another drawing number different from said one drawing number such that the enclosed sentences are assigned with said one drawing number.

5. The automatic patent drawings displaying device as claimed in claim 1, wherein when an element noun or an interrelationship definition of a paten section of “CLAIMS” of the patent document is selected, the drawing displaying element displays the drawing corresponding to the element noun or the interrelationship definition in the paragraph of the patent section of “DETAILED DESCRIPTION OF THE PREFERRED EMBODIMENTS”.

6. The automatic patent drawings displaying device as claimed in claim 1, wherein the drawing displaying element enables the selected paragraph and the drawing corresponding to the selected paragraph to be displayed.

7. The automatic patent drawings displaying device as claimed in claim 6, wherein the drawing displaying element enables the drawing to be displayed in a manner that the drawing corresponding to the paragraph is fixed relative to a display screen and the paragraph is scrollable according to a scrolling up/down operation.

8. The automatic patent drawings displaying device as claimed in claim 1, wherein the drawing displaying element is configured to enable a plurality of drawings to be displayed when the plurality of drawings corresponds to any portion of the selected paragraph in the patent section of “DETAILED DESCRIPTION OF THE PREFERRED EMBODIMENTS”.
